(19) United States
(12) Patent Application Publication
(10) Pub. No.: US 2012/0120379 A1
(43) Pub. Date: May 17, 2012

(54) SYSTEM AND METHOD FOR CONTROLLING THE DISTORTION OF A RETICLE

(76) Inventors: Alton H. Phillips, East Palo Alto, CA (US); Douglas C. Watson, Campbell, CA (US); Hiromitsu Yoshimoto, Saitama-City (JP); Hiroki Okuno, Fukaya-city (JP)

(21) Appl. No.: 13/090,183

(22) Filed: Apr. 19, 2011

Related U.S. Application Data
(63) Continuation-in-part of application No. 12/643,932, filed on Dec. 21, 2009.
(60) Provisional application No. 61/326,117, filed on Apr. 20, 2010.

(51) Int. Cl. G03B 27/68

(52) U.S. Cl. 355/52

(57) ABSTRACT

An apparatus for controlling the distortion of a reticle (28) includes a temperature adjuster (258) and a control system (226). The temperature adjuster (258) includes a plurality of adjuster elements (258E) that individually adjust the temperature of a plurality of regions (28R) of the reticle (28). The control system (226) includes a state observer (250) and a controller (260). The state observer (250) estimates an estimated physical condition (250C) of the reticle (28). The controller (260) controls the adjuster elements (258E) of the temperature adjuster (258) based at least in part on the estimated physical condition (250C).

### RELATED APPLICATION

This application claims priority on U.S. Provisional Application Ser. No. 61/326,117 filed on Apr. 20, 2010 and entitled “Device and Method for Controlling the Temperature of a Reticle”. As far as is permitted, the contents of U.S. Provisional Application Ser. No. 61/326,117 are incorporated herein by reference. This application is a continuation-in-part of U.S. application Ser. No. 12/643,932, filed on Dec. 21, 2009, and entitled “Reticle Error Reduction By Cooling”. As far as is permitted, the contents of U.S. application Ser. No. 12/643,932 are incorporated herein by reference.

### BACKGROUND

Projection lithography is a powerful and essential tool for microelectronics processing. In the semiconductor industry, there is a continuing trend toward higher device densities. To achieve these high densities there has been and continues to be efforts toward scaling down the device dimensions on semiconductor wafers. In order to accomplish such high device packing density, smaller features sizes are required.

In recent years, along with the miniaturization of patterns of semiconductor integrated circuits in a projection exposure apparatus, changes in imaging characteristics (e.g., the magnification, focal length, and the like of a projection optical system) can result due to absorption of exposure illumination light by a reticle. Stated another way, since exposure light rays are transmitted through the reticle or mask, the reticle can thermally deform due to absorption of exposure light, and, thus, the imaging characteristics can change due to the thermal deformation of the reticle. In particular, as the reticle is heated by the exposure illumination, this heat can result in a volumetric or thermal expansion, i.e. distortion, of the reticle. This volumetric or thermal expansion of the reticle can result in a corresponding translational distortion of the two-dimensional patterns on the reticle, and therefore a translational distortion of the copied patterns on the wafer. Thus, the performance of the lithographic apparatus may be adversely affected. Further, optical methods for making in-situ, direct, reticle pattern distortion measurements, which may be attempted to combat the above problem, are complex, expensive, and may require special gratings on the reticle.

The potential thermal distortion of a reticle due to the absorption of exposure light can be broken down into acceptable or desired reticle distortion, and unacceptable or undesired reticle distortion. Acceptable reticle distortion is a linear distortion of the reticle, which can relatively easily be compensated for by adjusting the speed in which the reticle is moved and/or making adjustments and/or alterations to the optical elements utilized in the lithography system to change the magnification. In contrast, unacceptable reticle distortion, which may result from uneven and/or pattern dependent heating of the reticle, is non-linear and may be more complex and unpredictable, and therefore can not be so easily compensated for. Additionally, the effect may be dependent on the mask transmission, which might vary over the reticle and from reticle to reticle. Moreover, when the reticle is moved (e.g., scanned) during exposure, a temperature variation, both spatially and in time, may occur. For example, since during scanning only a portion of the reticle is illuminated at any one time, the reticle may be distorted due to uneven heating or temperature gradients within the reticle. Accordingly, it is desired to control, inhibit and/or reduce the unacceptable reticle distortion, i.e. the non-linear portion of the reticle distortion, which can be caused by the heating of the reticle from absorption of exposure illumination light, by controlling the heat that is transferred to and from the reticle.

### SUMMARY

The present invention is directed to an apparatus for controlling the distortion of a reticle, the reticle including a plurality of regions. In certain embodiments, the apparatus includes a temperature adjuster and a control system. The temperature adjuster includes a plurality of adjuster elements that individually adjust the temperature of the plurality of regions of the reticle. The control system includes a state observer and a controller. The state observer estimates an estimated physical condition of the reticle. The controller controls the adjuster elements of the temperature adjuster based at least in part on the estimated physical condition.

As an overview, in certain embodiments, the apparatus is uniquely designed to utilize various inputs to estimate and control the distortion of the reticle so as to effectively control, inhibit and/or reduce any unacceptable distortion of the reticle.

In some embodiments, the apparatus further comprises a sensor that senses a sensed physical condition of the reticle. In such embodiments, the state observer estimates the estimated physical condition of the reticle based at least in part on the sensed physical condition. Additionally, the control system can further include a first comparator that compares the sensed physical condition with the estimated physical condition and generates a first physical condition error based on the difference between the sensed physical condition and the estimated physical condition. The first physical condition error can then be provided to the state observer. The state observer subsequently improves the estimate of the estimated physical condition based at least in part on the first physical condition error. Further, in one embodiment, the sensor can include one or more of a temperature sensor and an alignment mark sensor.

In some embodiments, the apparatus further comprises an evaluator that evaluates an evaluated physical condition of the reticle. In such embodiments, the state observer estimates the estimated physical condition of the reticle based at least in part on the evaluated physical condition. Additionally, the control system can further include a first comparator that compares the evaluated physical condition with the estimated physical condition and generates a first physical condition error based on the difference between the evaluated physical condition and the estimated physical condition. The first physical condition error can then be provided to the state observer. The state observer subsequently improves the estimate of the estimated physical condition based at least in part on the first physical condition error. Further, in one embodiment, the evaluator can include a pattern distortion evaluator.

Additionally, in certain embodiments, the control system further includes a second comparator that compares the estimated physical condition with a desired physical condition of the reticle. The second comparator generates a second physical condition error based on the difference between the estimated physical condition and the desired physical condition. In one such embodiment, the estimated physical condition and the desired physical condition relate to a pattern distortion of the reticle. Further, in one embodiment, the second physical condition error is provided to the controller. In such embodiment, the controller controls the adjuster elements of the temperature adjuster based at least in part on the second physical condition error.

Further, in one embodiment, the state observer and measured reticle surface temperatures are used to estimate one or more of the following parameters: (i) a pattern density of the reticle, (ii) a gas film thickness between the temperature adjuster and the reticle, (iii) a convection rate of the reticle, and (iv) a heat transfer rate through a control surface of each of the plurality of adjuster elements.

Additionally, in one embodiment, the state observer estimates the estimated physical condition of the reticle and/or improves the estimate of the estimated physical condition based at least in part on one or more of (i) a pattern density of the reticle, (ii) a gas film thickness between the temperature adjuster and the reticle, (iii) a convection rate of the reticle, and (iv) a heat transfer rate through a control surface of each of the plurality of adjuster elements.

Still further, the present invention is also directed to an exposure apparatus, a method for controlling the distortion of a reticle, and a method for transferring an image from the reticle to a device.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic illustration of an exposure apparatus having features of the present invention;

FIG. 2 is a simplified diagrammatic illustration of a reticle, one or more sensors, a temperature adjuster, and an embodiment of a reticle distortion control system having features of the present invention;

FIG. 3A is a simplified schematic illustration of the reticle, a temperature sensor and a state observer of a reticle distortion control system having features of the present invention;

FIG. 3B is a simplified schematic illustration of the reticle, the temperature sensor, a temperature adjuster and a state observer of a reticle distortion control system having features of the present invention;

FIG. 3C is a simplified schematic illustration of the reticle, the temperature sensor and a state observer of a reticle distortion control system having features of the present invention;

FIG. 3D is a simplified schematic illustration of one region of the reticle, an adjuster element of a temperature adjuster, and a state observer of a reticle distortion control system having features of the present invention;

FIG. 3E is a simplified schematic illustration of the reticle, an illumination system, an alignment mark sensor, and the first comparator and a state observer of a reticle distortion control system having features of the present invention;

FIG. 3F is a simplified schematic illustration of the reticle, the illumination system, a test wafer, the optical assembly, a pattern distortion evaluator, and the first comparator and a state observer of a reticle distortion control system having features of the present invention;

FIG. 4A is a simplified side view illustration of a reticle, a temperature adjuster, and temperature sensor that can be used in conjunction with the reticle distortion control system illustrated in FIG. 2;

FIG. 4B is a simplified top view illustration of the reticle and a portion of the temperature sensor illustrated in FIG. 4A;

FIG. 5A is a simplified schematic illustration of a reticle and an embodiment of a temperature adjuster that can be used in conjunction with the reticle distortion control system illustrated in FIG. 2;

FIG. 5B is a simplified bottom perspective view of a portion of the temperature adjuster illustrated in FIG. 5A;

FIG. 6A is a flow chart that outlines a process for manufacturing a device in accordance with the present invention; and

FIG. 6B is a flow chart that outlines device processing in more detail.

### DESCRIPTION

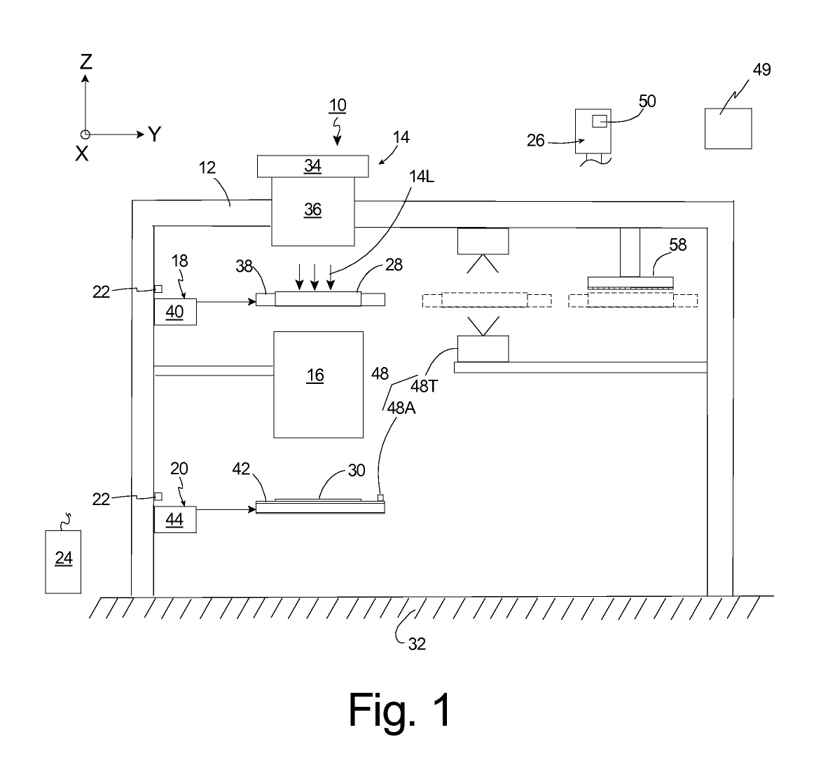

FIG. 1 is a schematic illustration of a precision assembly, namely an exposure apparatus 10, having features of the present invention. The exposure apparatus 10 includes an apparatus frame 12, an illumination system 14 (irradiation apparatus), an optical assembly 16, a reticle stage assembly 18, a wafer stage assembly 20, a measurement system 22, an assembly control system 24, one or more sensors 48, one or more evaluators 49, a temperature adjuster 58, and a reticle distortion control system 26. The design of the components of the exposure apparatus 10 can be varied to suit the design requirements of the exposure apparatus 10.

In certain Figures, an orientation system is included that illustrates an X axis, a Y axis that is orthogonal to the X axis, and a Z axis that is orthogonal to the X and Y axes. It should be noted that these axes can also be referred to as the first, second and third axes.

The exposure apparatus 10 is particularly useful as a lithographic device that transfers a pattern (not shown) of an integrated circuit from a reticle 28 onto a semiconductor wafer 30. The exposure apparatus 10 mounts to a mounting base 32, e.g., the ground, a base, or floor or some other supporting structure.

As an overview, in certain embodiments, the exposure apparatus 10 is uniquely designed to control, inhibit and/or reduce any unacceptable distortion of the reticle 28. More particularly, as illustrated and described herein, the reticle distortion control system 26 and the temperature adjuster 58 are uniquely designed to utilize various inputs to estimate and control the distortion of the reticle 28 so as to effectively control, inhibit and/or reduce any unacceptable distortion of the reticle 28. Additionally, the reticle distortion control system 26 and the temperature adjuster 58 are designed to control the temperature of the reticle 28 so as to reduce undesirable thermal deformation of the reticle 28 due to absorption of exposure illumination light.

Unfortunately, it can be very difficult to measure any distortion or deformation of the reticle 28 during normal usage. Accordingly, with the present system and method, the reticle distortion control system 26 utilizes a state observer 50 that is a simulated physical model of the reticle 28 that simulates conditions that are substantially similar to the conditions to which the reticle 28 itself is subjected. By effectively applying the same conditions to both the model of the reticle 28, i.e. through simulation, and the reticle 28 itself, and by evaluating any actual distortion that the reticle 28 may experience, the reticle distortion control system 26, via the state observer 50, can be utilized to control the temperature adjuster 58 and thus the distortion of the reticle 28. Further, with the various feedback mechanisms included herein, the model that is generated and/or applied by the state observer 50 can be regularly updated and improved so as to more accurately and effectively control, inhibit and/or reduce any undesired distortion of the reticle 28. Still further, with the method as described in detail herein, higher-order pattern distortion of the reticle 28 can be controlled, as opposed to previous methods, which are limited to only first and second order reticle pattern distortion corrections.

There are a number of different types of lithographic devices. For example, the exposure apparatus 10 can be used as a scanning type photolithography system that exposes the pattern from the reticle 28 onto the wafer 30 with the reticle 28 and the wafer 30 moving synchronously. Alternatively, the exposure apparatus 10 can be a step-and-repeat type photolithography system that exposes the reticle 28 while the reticle 28 and the wafer 30 are stationary.

However, the use of the exposure apparatus 10 provided herein is not limited to a photolithography system for semiconductor manufacturing. The exposure apparatus 10, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a reticle pattern from the reticle 28 to the wafer 30 with the reticle 28 closely located relative to the wafer 30, without the use of an optical assembly.

The apparatus frame 12 is rigid and supports the components of the exposure apparatus 10. The apparatus frame 12 illustrated in FIG. 1 supports the reticle stage assembly 18, the wafer stage assembly 20, the optical assembly 16 and the illumination system 14 above the mounting base 32. Additionally, the apparatus frame 12 can support at least one of the one or more sensors 48 above the mounting base 32.

The illumination system 14 includes an illumination source 34 and an illumination optical assembly 36. The illumination source 34 emits a beam (irradiation) of light energy 14L. The illumination optical assembly 36 guides the beam of light energy 14L from the illumination source 34 to the optical assembly 16. The beam of light energy 14L selectively illuminates different portions of the reticle 28 and exposes the wafer 30. In FIG. 1, the illumination source 34 is illustrated as being supported above the reticle stage assembly 18. Typically, however, the illumination source 34 is secured to one of the sides of the apparatus frame 12 and the energy beam from the illumination source 34 is directed to above the reticle stage assembly 18 with the illumination optical assembly 36.

The illumination source 34 can be a g-line source (436 nm), an i-line source (365 nm), a KrF excimer laser (248 nm), an ArF excimer laser (193 nm), a F₂ laser (157 nm), or an EUV source (13.5 nm). Alternatively, for example, the illumination source 34 can generate charged particle beams such as an x-ray or an electron beam. For instance, when the illumination source 34 generates an electron beam, thermionic emission type lanthanum hexaboride (LaB₆) or tantalum (Ta) can be used as cathodes in the electron gun. Still alternatively, the illumination source 34 can include wavelengths different from those specifically noted above.

The optical assembly 16 projects and/or focuses the light passing through the reticle 28 onto the wafer 30. Depending upon the design of the exposure apparatus 10, the optical assembly 16 can magnify or reduce the image illuminated on the reticle 28. The optical assembly 16 need not be limited to a reduction system. It could also be a 1× or magnification system.

The reticle stage assembly 18 holds and positions the reticle 28 relative to the optical assembly 16 and the wafer 30. In one embodiment, the reticle stage assembly 18 includes a reticle stage 38 that retains the reticle 28 and a reticle stage mover assembly 40 that moves and positions the reticle stage 38 and the reticle 28. For example, the reticle stage mover assembly 40 moves and positions the reticle stage 38 and the reticle 28 relative to the illumination system 14 and the optical assembly 16. Additionally, the reticle stage mover assembly 40 moves and positions the reticle stage 38 and the reticle 28 so that the reticle 28 can be exposed by the beam of light energy 14L from the illumination system 14, so that the reticle 28 can be measured or sensed by at least one of the one or more sensors 48, and so that the temperature of the reticle 28 can be adjusted by the temperature adjuster 58. For example, the reticle 28 can be moved from and between an exposure position (the left-most position of the reticle 28 in FIG. 1), a sensing position (the middle position of the reticle 28 in FIG. 1) and an adjustment position (the right-most position of the reticle 28 in FIG. 1).

Somewhat similarly, the wafer stage assembly 20 holds and positions the wafer 30 with respect to the projected image of the illuminated portions of the reticle 28. In one embodiment, the wafer stage assembly 20 includes a wafer stage 42 that retains the wafer 30, and a wafer stage mover assembly 44 that moves and positions the wafer stage 42 and the wafer 28. For example, the wafer stage mover assembly 44 moves and positions the wafer stage 42 and the wafer 30 relative to the optical assembly 16.

Each mover assembly 40, 44 can move the respective stage 38, 42 with three degrees of freedom, less than three degrees of freedom, or more than three degrees of freedom. The reticle stage mover assembly 40 and the wafer stage mover assembly 44 can each include one or more movers, such as rotary motors, voice coil motors, linear motors utilizing a Lorentz force to generate drive force, electromagnetic movers, planar motors, or some other force movers.

The measurement system 22 monitors movement of the reticle 28 and the wafer 30 relative to the optical assembly 16 or some other reference. With this information, the assembly control system 24 can control the reticle stage assembly 18 to precisely position the reticle 28 and can control the wafer stage assembly 20 to precisely position the wafer 30. The design of the measurement system 22 can vary. For example, the measurement system 22 can utilize multiple laser interferometers, encoders, and/or other measuring devices.

The assembly control system 24 is connected to the reticle stage assembly 18, the wafer stage assembly 20 and the measurement system 22. The assembly control system 24 receives information from the measurement system 22 and controls the stage assemblies 18, 20 to precisely position the reticle 28 and the wafer 30. The assembly control system 24 can include one or more processors and circuits.

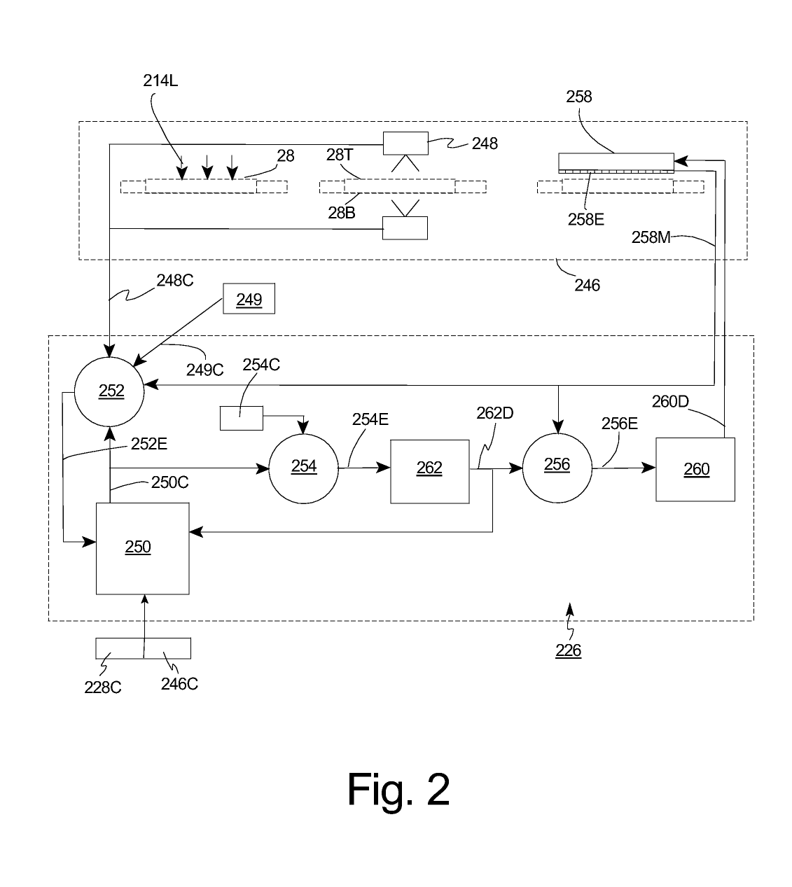

The one or more sensors 48 are adapted to sense certain sensed physical conditions 248C (illustrated in FIG. 2) of the reticle 28. The positioning of the one or more sensors 48 can be varied to suit the specific requirements of the exposure apparatus 10. For example, as illustrated, at least one of the sensors 48, e.g., a temperature sensor 48T, can be attached to the apparatus frame 12, and at least one of the sensors 48, e.g., an alignment mark sensor 48A, can be attached to the wafer stage 42. Additionally and/or alternatively, at least one of the sensors 48 can be attached to the temperature adjuster 58, at least one of the sensors 48 can be attached to the reticle stage 38, and/or at least one of the sensors 48 can be attached to a different part of the exposure apparatus 10.

The one or more evaluators 49 are adapted to evaluate certain evaluated physical conditions 249C (illustrated in FIG. 2) of the reticle 28 that can not be readily sensed or measured by the one or more sensors 48. The positioning of the one or more evaluators 49 can be varied to suit the specific requirements of the exposure apparatus 10. For example, as illustrated, at least one of the one or more evaluators 49, e.g., a pattern distortion evaluator, can be positioned remotely from the apparatus frame 12. Additionally and/or alternatively, at least one of the one or more evaluators 49 can be attached to a portion of the apparatus frame 12 and/or at least one of the one or more evaluators 49 can be attached to another portion of the exposure apparatus 10.

The temperature adjuster 58 is adapted to adjust the temperature of the reticle 28. In particular, the temperature adjuster 58 is controlled by the reticle distortion control system 26 to adjust the temperature of the reticle 28 so as to help effectively control the distortion of the reticle 28. Moreover, as described in detail below, the temperature adjuster 58 can be uniquely designed to individually and independently adjust the temperature of different regions of the reticle 28, as different regions of the reticle 28 may be subjected to different amounts of heating and/or different amounts of distortion.

The reticle distortion control system 26, as will be described in detail below, in conjunction with the temperature adjuster 58, can utilize various inputs in order to control, inhibit, and/or reduce any unacceptable distortion of the reticle 28 or reticles that are to be utilized in the exposure apparatus 10. In particular, in some embodiments, the exposure apparatus 10 can utilize more than one reticle 28, such that the reticle distortion control system 26 and the temperature adjuster 58 can effectively control the temperature of the reticles 28 so as to control, inhibit and/or reduce any undesirable distortion of the individual reticle 28 between uses or exposures of the individual reticle 28, i.e. while a reticle pattern from another reticle 28 is being exposed onto the wafer 30. In this way, the desired throughput or productivity of the exposure apparatus 10 can be maintained. Additionally, by controlling, inhibiting and/or reducing the undesirable distortion of the reticle 28, the exposure apparatus 10 can achieve improved quality in the patterns that are being transferred from the reticle 28 to the wafer 30.

FIG. 2 is a simplified diagrammatic illustration of the reticle 28, one or more sensors 248, one or more evaluators 249, a temperature adjuster 258, and an embodiment of a reticle distortion control system 226 having features of the present invention. In particular, as discussed above, the reticle distortion control system 226 includes at least a state observer 250 that includes a simulated physical model of the reticle 28 that simulates conditions that are substantially similar to the conditions to which the reticle 28 itself is subjected. Moreover, the state observer 250 can also include a model of the temperature adjuster 258, e.g., of the individual elements of the temperature adjuster 258, and the air gap between the reticle 28 and the temperature adjuster 258.

Moreover, the reticle distortion control system 226 is designed to receive various inputs, including from the one or more sensors 248 and the one or more evaluators 249, and to cooperate with the temperature adjuster 258 in order to control, inhibit, and/or reduce the undesirable distortion of the reticle 28 that is positioned within an environment 246. Further, within such environment 246, certain regions of the reticle 28 may be subjected to or otherwise influenced by elevated levels of heat. Stated another way, certain regions of the reticle 28 may be subjected to or otherwise influenced by increased temperatures due to certain factors and/or activities present or undertaken within the environment 246. For example, certain regions of the reticle 28 may be heated to different extents due to absorption of exposure illumination light 214L that is emitted by the illumination source 34 (illustrated in FIG. 1) and guided toward the reticle by the illumination optical assembly 36 (illustrated in FIG. 1). Thus, the reticle 28 will face thermal distortion due to the absorption of the exposure illumination light 214L.

The one or more sensors 248 are adapted to sense or measure one or more sensed physical conditions 248C of the reticle 28. For purposes of simplification of illustration, the sensed physical conditions 248C are illustrated in FIG. 2 as an output of the one or more sensors 248 that is directed toward the reticle distortion control system 226. In particular, the one or more sensors 248 can be utilized to sense certain sensed physical conditions 248C of the reticle 28, such as the temperature array or temperature map of a top surface 28T of the reticle 28, the temperature array or temperature map of a bottom surface 28B of the reticle 28, and/or the alignment mark positioning on the reticle 28. Stated another way, in different embodiments, the one or more sensors 248 can include one or more temperature sensors, and/or alignment mark sensors.

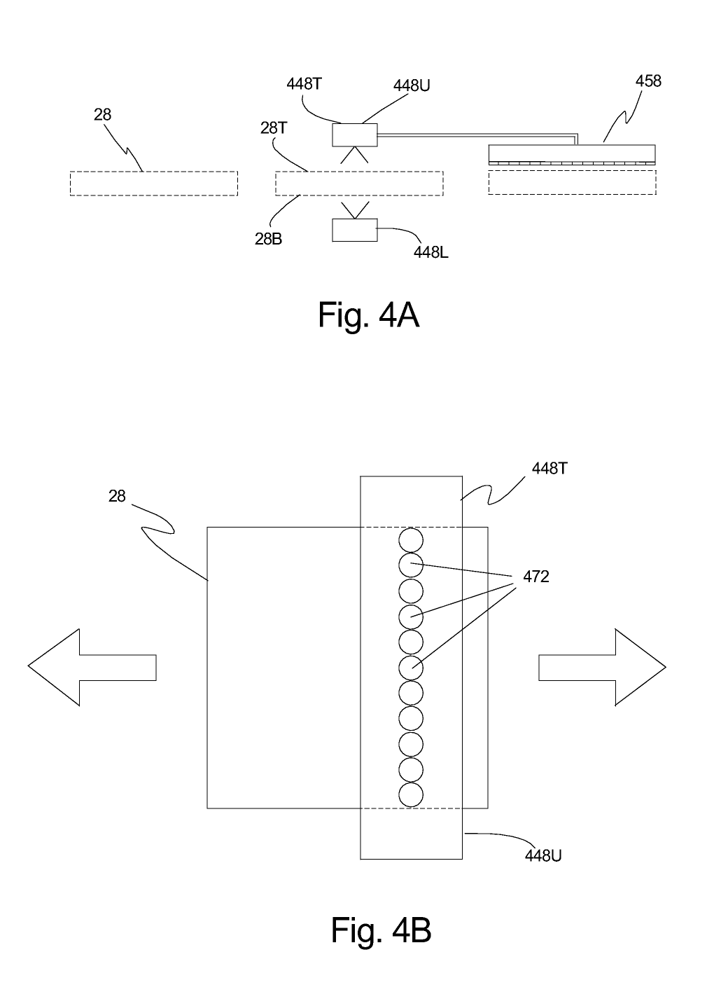

The design of the one or more sensors 248 can be varied to suit the specific requirements of the exposure apparatus 10. For example, in certain embodiments, the temperature sensors may include one or more infrared sensor arrays. An example of a suitable temperature sensor will be described in detail below in relation to FIG. 4A. Additionally, in certain embodiments, the alignment mark sensors 48A (illustrated in FIG. 1) can utilize, at least in part, data that is obtained from the assembly control system 24 (illustrated in FIG. 1) of the exposure apparatus 10. Additionally, the one or more sensors 248 can be utilized at different times and at different frequencies relative to the overall utilization of the reticle 28. For example, in certain embodiments, the temperature sensors may be utilized two times per wafer, and the alignment mark sensors may be utilized one time per lot.

Additionally, in certain embodiments, direct measurement of the reticle 28 can be done continuously during the scanning process and that information can be fed back into the model of the reticle 28 that is included in the state observer 250. An example of such embodiments is included in U.S. Provisional Application Ser. No. 61/405,592, filed on Oct. 21, 2010, and entitled “Apparatus and Method for Measuring Thermally Induced Reticle Distortion.” As far as is permitted, the contents of U.S. Provisional Application Ser. No. 61/405,592 are incorporated herein by reference.

Another example is included in U.S. Provisional Application Ser. No. 61/443,630, filed on Feb. 16, 2011, and entitled “Measuring Thermal Induced Reticle Distortion Using Coherent Light.” As far as is permitted, the contents of U.S. Provisional Application Ser. No. 61/443,630 are incorporated herein by reference.

The one or more evaluators 249 are used to evaluate one or more evaluated physical conditions 249C of the reticle 28. For purposes of simplification of illustration, the evaluated physical conditions 249C are illustrated as an output of the one or more evaluators 249 that is directed toward the reticle distortion control system 226. In particular, in some embodiments, the one or more evaluators 249 can be utilized to evaluate certain evaluated physical conditions 249C of the reticle 28, such as the pattern distortion of the reticle 28. Stated another way, in certain embodiments, the one or more evaluators 249 can include a pattern distortion evaluator.

The design of the one or more evaluators 249 can be varied to suit the specific requirements of the exposure apparatus 10. For example, in certain embodiments, the pattern distortion evaluator may include a microscope that can be utilized to evaluate data or conditions from on-wafer testing results, i.e. using a test wafer, and/or data or conditions from a custom reticle with several fiducial marks. Additionally, the one or more evaluators 249 can be utilized at different times and at different frequencies relative to the overall utilization of the reticle 28. For example, in certain embodiments, the pattern distortion evaluator may be utilized once per month to evaluate the pattern distortion that a reticle 28 may experience.

As stated above, the temperature adjuster 258 is adapted to adjust the temperature of the reticle 28. Additionally, in certain embodiments, as illustrated herein and as described in greater detail below, the temperature adjuster 258 can include a plurality of adjuster elements 258E, e.g., thermo electric modules (TEMs). With this design, each of the adjuster elements 258E can be energized individually and independently so as to enable the temperature adjuster 258 to individually and independently adjust the temperature of different regions of the reticle 28. This, in turn, enables the reticle distortion control system 226 and the temperature adjuster 258 to more accurately and effectively control, inhibit and/or reduce any undesirable distortion of the reticle 28. A discussion of a temperature adjuster 258 is included in U.S. Provisional Application Ser. No. 61/393,786, filed on Oct. 15, 2010, and entitled “Reticle Cooling Device With Integrated Infrared (IR) Sensors.” As far as is permitted, the contents of U.S. Provisional Application Ser. No. 61/393,786 are incorporated herein by reference.

The design of the reticle distortion control system 226 can be varied to suit the specific requirements of the exposure apparatus 10. In this embodiment, the reticle distortion control system 226 includes the state observer 250, a first comparator 252, a second comparator 254, a third comparator 256, and a controller 260. As will be described below, the reticle distortion control system 226 utilizes the inputs from the one or more sensors 248, the one or more evaluators 249 and elsewhere, and then controls the temperature adjuster 258 to effectively control, inhibit and/or reduce any undesirable distortion of the reticle 28.

As stated above, the state observer 250 is a computer generated physical model of the reticle 28 that simulates conditions that are substantially similar to the conditions to which the reticle 28 itself is subjected. Additionally, the state observer 250 is used to estimate one or more estimated physical conditions 250C of the reticle 28. For purposes of simplification of illustration, the estimated physical conditions 250C are illustrated in FIG. 2 as an output of the state observer 250 that is directed toward the first comparator 252 and/or the second comparator 254. More particularly, in some embodiments, the state observer 250 utilizes various observer inputs that are provided to the state observer 250 in order to generate the estimated physical conditions 250C of the reticle 28. For example, in different embodiments, the observer inputs may include (i) one or more reticle conditions 228C, which may be known or assumed features or conditions of the reticle 28 itself; (ii) one or more environment conditions 246C, which may be known or assumed features or conditions of the environment 246; (iii) the one or more sensed physical conditions 248C of the reticle 28 that have been sensed by the one or more sensors 248; and/or (iv) the one or more evaluated physical conditions 249C of the reticle 28 that have been evaluated by the one or more evaluators 249. Subsequently, the state observer 250 utilizes an algorithm that considers the one or more reticle conditions 228C, the one or more environment conditions 246C, the one or more sensed physical conditions 248C of the reticle 28, and/or the one or more evaluated physical conditions 249C of the reticle 28 to generate the one or more estimated physical conditions 250C of the reticle 28. Stated another way, in different embodiments, the state observer 250 utilizes a model of the reticle 28 to estimate the one or more estimated physical conditions 250C of the reticle 28 based at least in part on the one or more reticle conditions 228C, the one or more environment conditions 246C, the one or more sensed physical conditions 248C of the reticle 28, and/or the one or more evaluated physical conditions 249C of the reticle 28.

It should be noted that the reticle conditions 228C and the environment conditions 246C affect how the reticle 28 responds to any treatment or temperature adjustment that is provided to the reticle 28 by the temperature adjuster 258 under control of the reticle distortion control system 226.

It should further be noted that the physical conditions of the reticle 28 may also be referred to as state variables. Stated another way, the sensed physical conditions 248C of the reticle 28 may be referred to as the sensed state variables, the evaluated physical conditions 249C of the reticle 28 may be referred to as evaluated state variables, and the estimated physical conditions 250C of the reticle 28 may be referred to as the estimated state variables.

In different embodiments, the one or more reticle conditions 228C can include reticle size, density thermal conductivity, specific heat, gas film thickness map, thermal conductivity, reticle pattern size, reticle pattern density map, fiducial mark positions, reticle stage trajectory, reticle convection map, reticle chuck thermo mechanical properties, and/or other reticle conditions. Additionally, in different embodiments, the one or more environment conditions 246C can include ambient temperature, environmental pressure, and/or other environmental conditions.

Further, in different embodiments, the one or more estimated physical conditions 250C of the reticle 28 that are estimated by the state observer 250 can include the temperature array or temperature map of the top surface 28T of the reticle 28, the temperature array or temperature map of the bottom surface 28B of the reticle 28, the alignment mark positioning on the reticle 28, and/or the reticle pattern distortion of the reticle 28.

The state observer 250 utilizes continuous and/or periodic feedback, as described in detail herein, to improve the accuracy of the estimated physical conditions 250C of the reticle 28, by adjusting the parameters until the sensed or evaluated inputs and the estimated outputs are optimized such that they are substantially equal.

As illustrated in this embodiment, the first comparator 252 compares the sensed physical conditions 248C of the reticle 28 that are sensed by the one or more sensors 248 and the evaluated physical conditions 249C of the reticle 28 that are evaluated by the one or more evaluators 249 with the estimated physical conditions 250C of the reticle 28 that are generated by the state observer 250. Within this comparison by the first comparator 252, a state variable error 252E is generated, i.e. an error for each of the sensed physical conditions 248C or evaluated physical conditions 249C versus the estimated physical conditions 250C, and the state variable error 252E is then fed back into the state observer 250 to improve the model. As a result thereof, subsequent estimated physical conditions 250C generated by the state observer 250 will be based on the improved model that is based at least in part by the state variable error 252E. Stated another way, the estimated physical condition 250C is improved, i.e. the estimate is made closer to reality, based at least in part on the measured or sensed physical condition 248C or the evaluated physical condition 249C. Modifications to the model or algorithm utilized by the state observer 250 can be made to improve its accuracy by adjusting certain model parameters until the measurable inputs, e.g., the sensed physical conditions 248C of the reticle 28 and/or the evaluated physical conditions 249C of the reticle 28, and estimated outputs, e.g., the estimated physical conditions 250C of the reticle 28, are substantially equal. Stated another way, the state observer 250 utilizes continuous and/or periodic feedback to improve the accuracy of the estimated physical conditions 250C of the reticle 28, by adjusting the parameters until the state variable error is approximately zero.

As illustrated in this embodiment, the second comparator 254 compares an estimated physical condition 250C of the reticle 28 with a desired physical condition 254C of the reticle 28 to calculate a condition error. In particular, in one embodiment, the second comparator 254 compares an estimated pattern distortion of the reticle 28, as presently estimated by the state observer 250, with a desired pattern distortion of the reticle 28, which can based on simulation or empirical testing or some other method, to calculate a distortion error 254E. Stated another way, the difference between the estimated pattern distortion of the reticle 28 and the desired pattern distortion of the reticle 28 is calculated and/or generated within the second comparator 254, and the result or output is the distortion error 254E.

Subsequently, the distortion error 254E is fed into a desired temperature array generator 262, e.g., a matrix, which generates a desired temperature array 262D for the temperature adjuster 258 as a function of the distortion error 254E. Stated another way, the desired temperature array generator 262 generates the desired temperature array 262D for the temperature adjuster 258, i.e. the desired temperature for each of the adjuster elements 258E, which, based on the various inputs and outputs of the reticle distortion control system 226, will produce the necessary temperature adjustment for the different regions of the reticle 28. Thus, the amount of heat that needs to be transferred to or from each region of the reticle 28 will be known such that the temperature adjustments to the different regions of the reticle 28 will produce the desired pattern distortion of the reticle 28, i.e. will control, inhibit and/or reduce any undesirable distortion of the reticle 28.

As shown in the embodiment illustrated in FIG. 2, the third comparator 256 receives the desired temperature array 262D for the temperature adjuster 258 and compares that to a measured temperature array 258M for the temperature adjuster 258 to determine a temperature array error 256E. Stated another way, the difference between the desired temperature array 262D for the temperature adjuster 258 and the measured temperature array 258M for the temperature adjuster 258 is calculated and/or generated within the third comparator 256, and the result or output is the temperature array error 256E. Accordingly, the third comparator 256 effectively calculates errors for each of the adjuster elements 258E of the temperature adjuster 258 that need to be compensated for and/or corrected so that the temperature adjuster 258 can accurately adjust the temperature of one or more regions of the reticle 28.

Additionally, the desired temperature array 262D for the temperature adjuster 258 is also fed back into the state observer 250 as one of the observer inputs that help to improve the accuracy of the model of the reticle 28 and thus the accuracy of the estimated physical conditions 250C of the reticle 28, including the estimated pattern distortion of the reticle 28, as estimated by the state observer 250.

Further, the measured temperature array 258M for the temperature adjuster 258 is also fed into the first comparator 252 to assist in the generation or calculation of the state variable error 252E.

Subsequent to the determination of the temperature array error 256E in the third comparator 256, the temperature array error 256E is fed into the controller 260, which determines the desired current 260D or array duty cycles that needs to be sent to each of the adjuster elements 258E within the temperature adjuster 258 in order to create the desired temperature array 262D for the temperature adjuster 258. As shown herein, the adjuster elements 258E of the temperature adjuster 258, as energized by the desired current 260D determined by the controller 260, are then utilized to adjust the temperature, e.g., to cool or heat, the various regions of the reticle 28 as desired, based on the preceding feedback. Stated another way, the controller 260 independently and individually controls the operation of each of the adjuster elements 258E of the temperature adjuster 258, which are in turn used to adjust the temperature of the various regions of the reticle 28, and such adjustments are based at least in part on the estimated pattern distortion of the reticle 28 and the desired pattern distortion of the reticle 28. Stated still another way, the controller 260 determines the temperature map of the temperature adjuster 258 that will provide the desired temperature adjustment of the reticle 28 and thus achieve the desired pattern distortion of the reticle 28.

In some embodiments, within each temperature adjustment cycle of the reticle 28, i.e. during the temperature adjustment of the reticle 28 after each exposure of the reticle 28, the feedback loop between and among the third comparator 256, the controller 260 and the temperature adjuster 258 can be repeated as necessary in order to decrease the temperature array error 256E to the extent possible as determined by the third comparator 256. Stated another way, the feedback loop between and among the third comparator 256, the controller 260 and the temperature adjuster 258 can be repeated as necessary so that the measured temperature array 258M for the temperature adjuster 258, i.e. the measured temperature for each of the adjuster elements 258E, is substantially equal to the desired temperature array 262D for the temperature adjuster 258, i.e. the desired temperature for each of the adjuster elements 258E.

It should be noted that the use of the terms “first comparator”, “second comparator”, and “third comparator” is merely for ease of discussion, and it is not intended to denote any particular significance, priority and/or order of use. Accordingly, any of the comparators as described herein can be referred to as the “first comparator”, the “second comparator”, and/or the “third comparator”.

Further, it should be noted that although the reticle distortion control system 226, as illustrated and described in detail herein, is utilized to control, inhibit, and/or reduce the distortion of the reticle 28, the reticle distortion control system 226 is equally applicable to control, inhibit, and/or reduce the distortion of another type of workpiece.

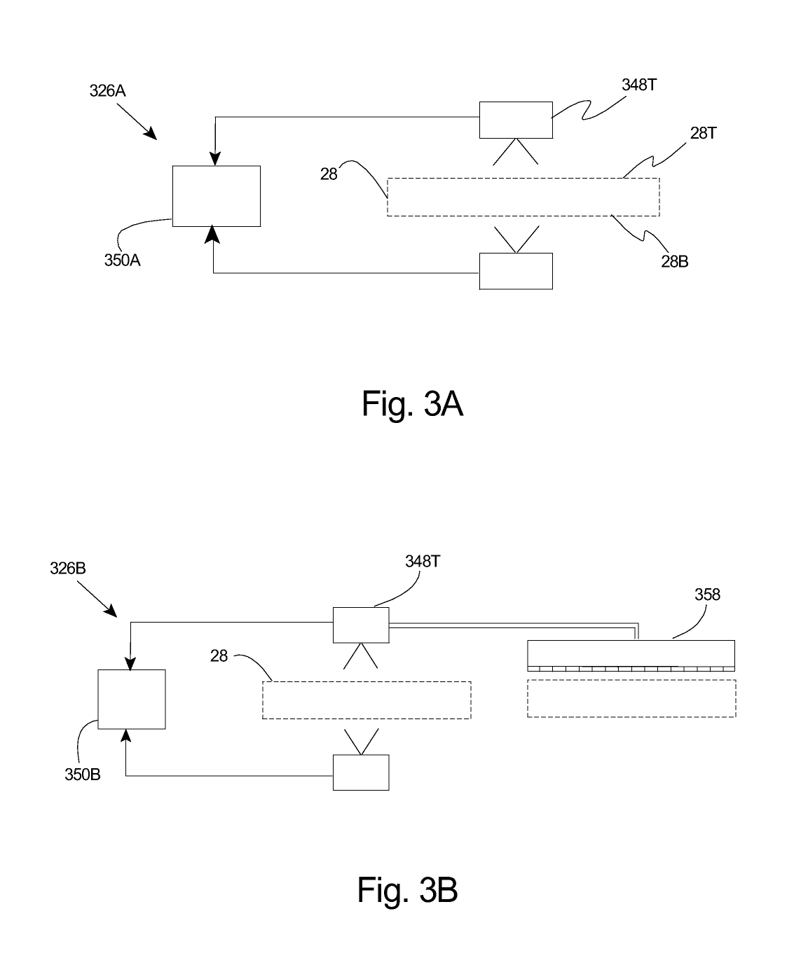

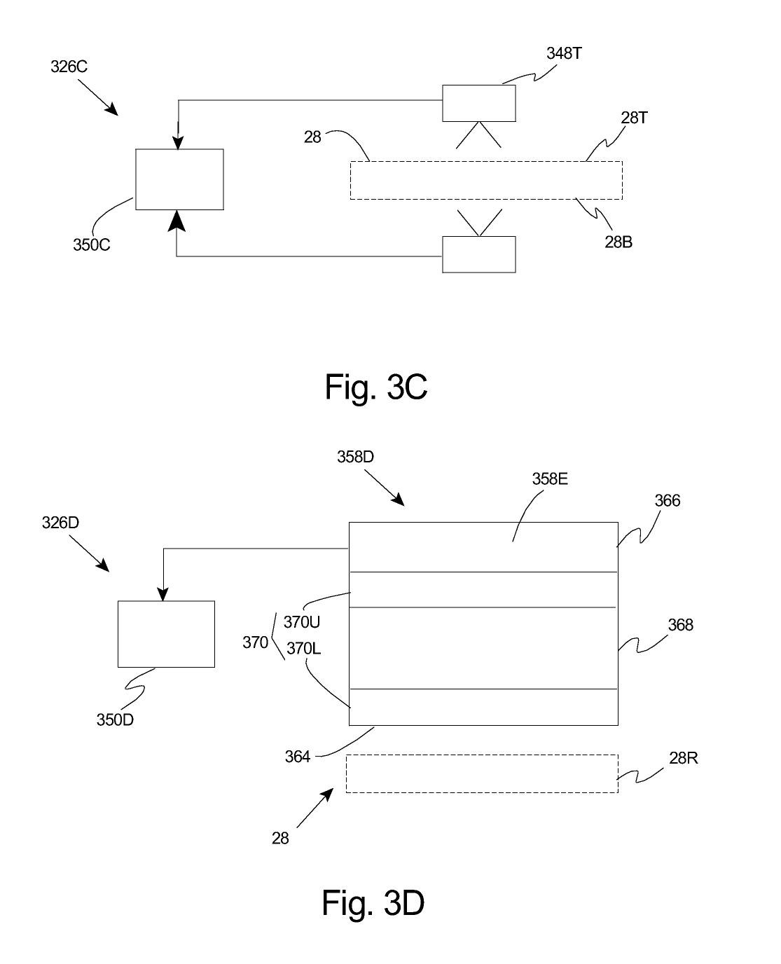

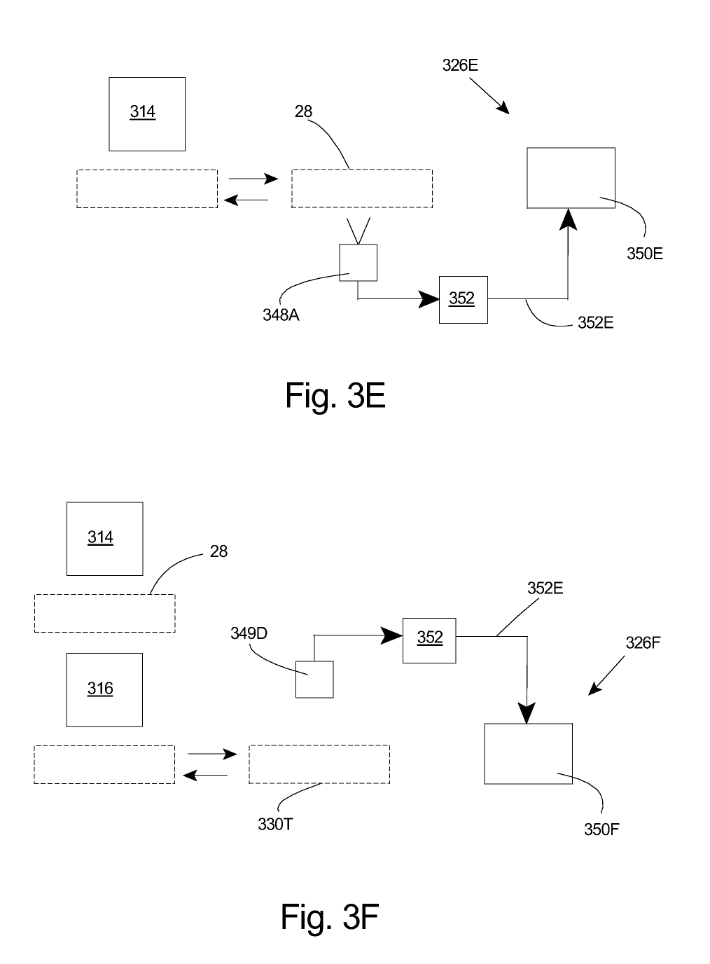

Various inputs, at least some of which have been mentioned above, can be used in order to improve the model of the reticle 28 of the state observer 250. For example, as discussed below, the state observer 250 can utilize such inputs as the pattern density map of the reticle 28 (see FIG. 3A), the gas film thickness between the temperature adjuster 358 and the reticle 28 (see FIG. 3B), the reticle convection map of the reticle 28 (see FIG. 3C), the heat transfer rate from the temperature adjuster 358D (see FIG. 3D), and the positioning of the alignment marks on the reticle 28 (see FIG. 3E). Further, the state observer 250 can also utilize a measurement of the pattern distortion of the reticle 28 as evaluated using a test wafer by one of the one or more evaluators 349 (see FIG. 3F).

FIG. 3A is a simplified schematic illustration of the reticle 28, a temperature sensor 348T, and a state observer 350A of a reticle distortion control system 326A having features of the present invention. It should be noted that the first comparator has been omitted in FIG. 3A for purposes of clarity.

During the exposure process, one factor that influences the amount of heat transferred to the reticle 28 is the pattern density of the reticle 28. In particular, the regions of the reticle 28 having a higher pattern density typically experience larger temperature changes during the exposure process. Unfortunately, the reticle pattern density is not always known to the manufacturer of the exposure apparatus 10 (illustrated in FIG. 1). Thus, an estimated pattern density map of the reticle 28 can be a valuable input for improving the model of the reticle 28 as provided by the state observer 350A, and thus for improving the estimated pattern distortion of the reticle 28 obtained from the state observer 350A.

Initially, in one embodiment, the reticle distortion control system 326A assumes that the reticle temperature is uniform and equal to the temperature of the environment around the exposure apparatus 10, e.g., 22 degrees Celsius. Alternatively, the temperature map of the top surface 28T and/or the bottom surface 28B of the reticle 28 can be measured with the temperature sensor 348T. Additionally, in one embodiment, the reticle distortion control system 326A assumes that the pattern density map is uniform across the reticle 28. The state observer 350A utilizes the assumption of the uniform pattern density map as an initial baseline estimate of the pattern density map of the reticle 28. Alternatively, in one embodiment, the reticle distortion control system 326A assumes no particular pattern shape or density, i.e. the reticle distortion control system 326A assumes a null pattern, to be utilized by the state observer 350A as an initial baseline estimate of the pattern density map of the reticle 28.

Next, the reticle 28 is illuminated to expose the wafer 30 (illustrated in FIG. 1). Subsequently, a temperature map of the top surface 28T and/or the bottom surface 28B of the reticle 28 is measured with the temperature sensor 348T.

Next, the difference in the measured post-exposure temperature map of the reticle 28 and the estimated temperature map of the reticle 28 is determined. As noted above, the regions of the reticle 28 that experienced greater temperature changes, e.g., became hotter, are the regions of the reticle 28 that have a higher pattern density.

Then, the pattern density map of the reticle 28 as estimated in the state observer 350A is modified, i.e. improved, using multiple linear regression analysis and influence functions, and/or a non-linear optimizer. The above steps can then be repeated as necessary until the estimated and measured post-exposure temperature maps are substantially equal and/or until the relevant state variable error 252E (illustrated in FIG. 2) is approximately zero. Accordingly, in this embodiment, the pattern density map of the reticle 28 can be effectively estimated based on the amount that the reticle 28 is heated during one or more exposures of the wafer 30. It should be noted that the last two steps, as noted above, can be conducted while the reticle 28 is being cooled and while a second wafer 30 is being exposed so as to inhibit any negative impact of the productivity of the exposure apparatus 10.

If a pattern density map is provided to the state observer 350A, a similar process to that described above can be used to refine other aspects of the state observer 350A model. For example, a similar process can be utilized to estimate the reticle convection map of the reticle 28, as described in FIG. 3C.

In one alternative embodiment, a white-light camera, or a camera that detects non-actinic radiation emitted by, reflected by, and/or transmitted through the pattern surface, can be utilized to measure the pattern density map of the reticle 28. Yet alternatively, existing hardware in the exposure apparatus 10 can be utilized to measure the pattern density map of the reticle 28. For example, movable blinds and an actinic light source can be used to expose subsections of the pattern, and an intensity sensor on the wafer or metrology stage can be used to measure the reticle transmittance, i.e. the pattern density.

FIG. 3B is a simplified schematic illustration of the reticle 28, the temperature sensor 348T, a temperature adjuster 358 and a state observer 350B of a reticle distortion control system 326B having features of the present invention. It should be noted that the first comparator has been omitted in FIG. 3B for purposes of clarity.

When the temperature of the reticle 28 is being adjusted with the temperature adjuster 358, one factor that influences how efficiently and/or effectively the temperature of the reticle 28 is adjusted is the gas film thickness between the temperature adjuster 358 and the reticle 28. In particular, the temperature of the regions of the reticle 28 wherein a smaller gas film thickness exists can typically be adjusted more efficiently. Thus, an estimated gas film thickness between the temperature adjuster 358 and the reticle 28 when the reticle 28 is in the adjustment position can be a valuable input for improving the model of the reticle 28 as provided by the state observer 350B, and thus for more efficiently controlling the temperature adjustment of the reticle 28 with the temperature adjuster. Stated another way, the state observer 350B is better able to control the temperature adjuster 358 when the distance between the temperature adjuster 358 and the reticle 28 can be accurately estimated.

Initially, in one embodiment, the reticle distortion control system 326B assumes that the reticle temperature is uniform and equal to the temperature of the environment around the exposure apparatus 10, e.g., 22 degrees Celsius. Alternatively, the temperature map of the top surface 28T and/or the bottom surface 28B of the reticle 28 can be measured with the temperature sensor 348T. Additionally, in one embodiment, the reticle distortion control system 326B assumes that the gas film thickness is uniform and equal to a nominal thickness, e.g., 20 μm. The state observer 350B utilizes the assumption of the uniform and nominal gas film thickness as an initial baseline estimate of the gas film thickness between the temperature adjuster 358 and the reticle 28.

Next, the temperature map of the temperature adjuster 358 is set to a predetermined mapping, e.g., 10 degrees Celsius everywhere.

Subsequently, after the reticle 28 is loaded onto the reticle stage 38 (illustrated in FIG. 1) the reticle 28 is cooled by the temperature adjuster 358 for a known duration, e.g., one second. Substantially immediately afterward, the temperature map of the reticle 28 is measured by the temperature sensor 348T.

Then, the difference in the measured and the estimated (or assumed) temperature maps of the reticle 28 is determined. As noted above, the regions of the reticle 28 that experienced more efficient temperature adjustment, i.e. experienced greater temperature changes, typically have a smaller gas film thickness between the temperature adjuster 358 and the reticle 28.

Finally, the gas film thickness map between the temperature adjuster 358 and the reticle 28 as estimated in the state observer 350B is modified, i.e. improved, using multiple linear regression analysis and influence functions, and/or a non-linear optimizer, until the estimated and measured temperature maps of the reticle 28 are substantially equal and/or until the relevant state variable error 252E (illustrated in FIG. 2) is approximately zero. Accordingly, in this embodiment, the gas film thickness map between the temperature adjuster 358 and the reticle 28 can be effectively estimated based on the amount that the reticle 28 has been cooled or heated while being subjected to and/or influenced by the temperature adjuster 358 for a known duration. It should be noted that the last two steps, as noted above, can be conducted while the first wafer 30 (illustrated in FIG. 1) in a lot is being exposed so as to inhibit any negative impact of the productivity of the exposure apparatus 10.

FIG. 3C is a simplified schematic illustration of the reticle 28, the temperature sensor 348T, and a state observer 350C of a reticle distortion control system 326C having features of the present invention. It should be noted that the first comparator has been omitted in FIG. 3C for purposes of clarity.

During the exposure process, one factor that influences the temperature change of the reticle 28 is the how different areas of the reticle 28 transfer heat via convection to the surrounding environment. In particular, the regions of the reticle 28 having a higher convection rate typically experience smaller temperature changes during the exposure process as the heat is more readily transferred to the surrounding environment. Unfortunately, the reticle convection rate to the surrounding environment is not usually known to the manufacturer of the exposure apparatus 10 (illustrated in FIG. 1). Thus, an estimated reticle convection map of the reticle 28 can be a valuable input for improving the model of the reticle 28 as provided by the state observer 350C, and thus for improving the estimated pattern distortion of the reticle 28 obtained from the state observer 350C.

Initially, in one embodiment, the reticle distortion control system 326C assumes that the reticle temperature is uniform and equal to the temperature of the environment around the exposure apparatus 10, e.g., 22 degrees Celsius. Alternatively, the temperature map of the top surface 28T and/or the bottom surface 28B of the reticle 28 can be measured with the temperature sensor 348T. Additionally, in this embodiment, the pattern density of the reticle 28 is known and inputted into reticle distortion control system 326C.

Next, the reticle 28 is illuminated to expose the wafer 30 (illustrated in FIG. 1). Subsequently, a temperature map of the top surface 28T and/or the bottom surface 28B of the reticle 28 is measured with the temperature sensor 348T.

Then, the difference in the measured post-exposure temperature map of the reticle 28 and the estimated temperature map of the reticle 28 is determined. As noted above, the regions of the reticle 28 that experienced smaller than expected temperature changes are the regions of the reticle 28 that have a higher convection rate.

Finally, the reticle convection map of the reticle 28 as estimated in the state observer 350C is modified, i.e. improved, using multiple linear regression analysis and influence functions, and/or a non-linear optimizer. The above steps can then be repeated as necessary until the estimated and measured post-exposure temperature maps are substantially equal and/or until the relevant state variable error 252E (illustrated in FIG. 2) is approximately zero. Accordingly, in this embodiment, the reticle convection map of the reticle 28 can be effectively estimated based on the amount that the reticle 28 is heated during one or more exposures of the wafer 30. It should be noted that the last two steps, as noted above, can be conducted while the reticle 28 is being cooled and while a second wafer 30 is being exposed so as to inhibit any negative impact of the productivity of the exposure apparatus 10.

FIG. 3D is a simplified schematic illustration of one region 28R of the reticle 28, an adjuster element 358E of a temperature adjuster 358D, and a state observer 350D of a reticle distortion control system 326D having features of the present invention. It should be noted that the first comparator has been omitted in FIG. 3D for purposes of clarity.

When the temperature of the reticle 28 is being adjusted with the temperature adjuster 358, one factor that indicates how efficiently the temperature of the reticle 28 is adjusted is the heat transfer rate through a control surface 364 of the temperature adjuster 358D. In particular, the temperature of the regions of the reticle 28 wherein the heat transfer rate of the corresponding adjuster element 358E is higher will be adjusted more efficiently. Thus, an estimated heat transfer rate through the control surface 364 of the temperature adjuster 358D can be a valuable input for improving the model of the reticle 28 as provided by the state observer 350A, and thus for improving the estimated pattern distortion of the reticle 28 obtained from the state observer 350A. Moreover, the heat transfer rate by which the temperature adjuster 358D is able to add or remove heat from the various regions of the reticle 28 is an important feature to know and understand in order to generate the desired temperature change in the reticle 28 that will effectively control, inhibit and/or reduced any undesired reticle pattern distortion on the reticle 28.

As illustrated, the adjuster element 358E is uniquely designed to enable an accurate determination of the heat transfer rate through the control surface 364 of the adjuster element 358E. With this design, the adjuster element 358E can be utilized to transfer an amount of heat or cooling to the reticle 28 to effectively control the temperature map, and thus the thermal expansion and the reticle pattern distortion of the reticle 28.

As illustrated, the adjuster element 358E includes a heat pump 366, the control surface 364, a known thermal resistance path 368, and a pair of temperature sensors 370 that are positioned on either side of the known thermal resistance path 368. Stated another way, the pair of temperature sensors 370 are separated by the known thermal resistive path 368, and are used to estimate the heat pumped through the control surface 364 of the adjuster element 358E. Further, each adjuster element 358E can include a similar design.

The heat pump 366 is designed to provide a desired amount of heating or cooling to the region 28R of the reticle 28.

As illustrated, the pair of temperature sensors 370 includes a lower sensor 370L and an upper sensor 370U. The lower sensor 370L senses the temperature of the adjuster element 358E below the known thermal resistive path 368, i.e. at the control surface 364. Additionally, the upper sensor 370U senses the temperature of the adjuster element 358E above the known thermal resistive path 368. Accordingly, the heat transfer rate through the control surface 364 can be determined by comparing the temperatures as sensed by the upper and lower sensors 370U, 370L.

In particular, an accurate heat transfer rate can be calculated by multiplying the thermal conductance of the known resistive path 368 by the difference between the temperatures sensed by the lower sensor 370L and upper sensor 370U.

Moreover, once the heat transfer rate is determined, that information is fed into the state observer 350D to enable the state observer 350D to more accurately estimate the state variables of the reticle 28, such as the estimated reticle pattern distortion. Additionally, the heat transfer rate can also be utilized to enable the controller 260 (illustrated in FIG. 2) to more accurately and effectively control the adjuster element 358E so as to better control the temperature of the region 28R of the reticle 28 and the corresponding reticle pattern distortion of the reticle 28.

Alternatively, the temperature sensors 370 and the known thermal resistive path 368 can be replaced with a thermo-electric flux sensor whose electrical output is proportional to the flux passing through the sensor. Some such thermo-electric flux sensors are manufactured by RdF Corporation.

FIG. 3E is a simplified schematic illustration of the reticle 28, an illumination system 314, an alignment mark sensor 348A, and the first comparator 352 and a state observer 350E of a reticle distortion control system 326E having features of the present invention. One way to determine the actual deformation of the reticle 28 is to analyze the positioning of the alignment marks on the reticle 28. Thus, knowledge of the actual position of the alignment marks of the reticle 28 can be a valuable input for improving the model of the reticle 28 as provided by the state observer 350E, and thus for improving the estimated pattern distortion of the reticle 28 obtained from the state observer 350E.

As is known, the reticle 28 can include a plurality of alignment marks (not illustrated) that enable the reticle 28 to be properly positioned when being illuminated by the illumination system 314. Initially, the alignment mark sensor 348A is utilized to sense the position of the alignment marks on the reticle 28 prior to the reticle 28 being illuminated by the illumination system 314. This information can also be provided to the state observer 350E. Alternatively, this data can be known prior to the use of the reticle 28, and may not need to be sensed directly by the alignment mark sensor 348A.

Subsequently, the reticle 28 is illuminated by the illumination system 314. Then, the alignment mark sensor 348A is again utilized to sense the position of the alignment marks of the reticle 28.

Next, the first comparator 352 determines the difference in the measured position of the alignment marks of the reticle 28 post-exposure and the estimated position of the alignment marks of the reticle 28 post-exposure as obtained from the state observer 350E, i.e. determines the state variable error 352E.

Finally, the state variable error 352E is fed from the first comparator 352 to the state observer 350E to improve the model of the state observer 350E to more accurately estimate the estimated pattern distortion of the reticle 28.

FIG. 3F is a simplified schematic illustration of the reticle 28, the illumination system 314, a test wafer 330T, the optical assembly 316, a pattern distortion evaluator 349D, and the first comparator 352 and a state observer 350F of a reticle distortion control system 326F having features of the present invention. During the exposure process, the pattern (not illustrated) that is to be transferred from the reticle 28 to the wafer 30 (illustrated in FIG. 1) can become distorted. Thus, an ability to evaluate the distortion of the pattern that is transferred to the test wafer 330T can be a valuable input for improving the model of the reticle 28 as provided by the state observer 350F, and thus for improving the estimated pattern distortion of the reticle 28 obtained from the state observer 350F.

Initially, the pattern distortion evaluator 349D, e.g., a microscope or the like, is utilized to evaluate the pattern on the reticle 28 prior to the reticle 28 being illuminated by the illumination system 314.

Subsequently, the reticle 28 is illuminated by the illumination system 314 and the test wafer 330T is exposed by the optical assembly 316, and the pattern is transferred to the test wafer 330T.

Then, the pattern distortion evaluator 349D is utilized to evaluate the condition and quality of the pattern, and thus the pattern distortion, on the test wafer 330T.

Next, the first comparator 352 determines the difference in the evaluated pattern distortion on the test wafer 330T and the estimated pattern distortion of the reticle 28 as obtained from the state observer 350F, i.e. determines the state variable error 352E.

Finally, the state variable error 352E is fed from the first comparator 352 to the state observer 350E to improve the model of the state observer 350E to more accurately estimate the estimated pattern distortion of the reticle 28. Alternatively, in one embodiment, the above-recited process can be utilized with a production wafer, instead of the test wafer 330T. In such embodiment, the corrections and/or improvements to the model of the state observer 350E can be made during the wafer production process.

FIG. 4A is a simplified side view illustration of the reticle 28 (illustrated in phantom in three different positions to emphasize movement), a temperature adjuster 458, and an embodiment of a temperature sensor 448T that can be used in conjunction with the reticle distortion control system 226 illustrated in FIG. 2. In particular, FIG. 4A illustrates the relative positioning of the reticle 28 during exposure (in the exposure position), while the temperature of the reticle 28 is being sensed by the temperature sensor 448T (in the sensing position), and while the temperature of the reticle 28 is being adjusted, i.e. cooled, by the temperature adjuster 458 (in the adjustment position).

The design of the temperature sensor 448T can be varied to suit the requirements of the reticle distortion control system 226 and/or the exposure apparatus 10 (illustrated in FIG. 1). As illustrated in FIG. 4A, the temperature sensor 448T can include an upper sensor array 448U and a lower sensor array 448L. In this embodiment, the upper sensor array 448U and the lower sensor array 448L are positioned substantially directly opposite from each other on either side of the reticle 28, i.e. top and bottom, while the temperature of the reticle 28 is being sensed. Alternatively, the upper sensor array 448U and the lower sensor array 448L can be somewhat offset from each other on either side of the reticle 28 while the temperature of the reticle 28 is being sensed.

The upper sensor array 448U is adapted to sense the temperature of the top surface 28T of the reticle 28 as the reticle 28 moves through the sensing position from the exposure position to the adjustment position and from the adjustment position to the exposure position.

In one embodiment, the upper sensor array 448U includes a plurality of infrared sensors 472 (illustrated in FIG. 4B) to enable a more accurate and precise sensing of the temperature across the top surface 28T of the reticle 28. Alternatively, the upper sensor array 448U can have a different design.

Somewhat similarly, the lower sensor array 448L is adapted to sense the temperature of the bottom surface 28B of the reticle 28 as the reticle 28 moves through the sensing position from the exposure position to the adjustment position and from the adjustment position to the exposure position.

In one embodiment, the lower sensor array 448L includes a plurality of infrared sensors (not illustrated) to enable a more accurate and precise sensing of the temperature across the bottom surface 28B of the reticle 28. Alternatively, the lower sensor array 448L can have a different design.

Additionally, in one embodiment, the upper sensor array 448U is attached to the temperature adjuster 258. Alternatively, the upper sensor array 448U can be attached to a different portion of the exposure apparatus 10. Additionally, the lower sensor array 448L can alternatively be attached to various portions of the exposure apparatus 10. For example, in one such embodiment, the lower sensor array 448L is attached to the reticle stage 38 (illustrated in FIG. 1).

FIG. 4B is a simplified top view illustration of the reticle 28 and a portion of the temperature sensor 448T illustrated in FIG. 4A. In particular, FIG. 4B illustrates the movement of the reticle 28 relative to the upper sensor array 448U of the temperature sensor 448T illustrated in FIG. 4A.

As shown in FIG. 4B, the upper sensor array 448U includes the plurality of infrared sensors 472 that extend laterally such that the infrared sensors 472 are able to provide accurate and precise temperature measurements across the top surface 28T of the reticle 28 in a direction substantially orthogonal to the direction of motion of the reticle 28 between the exposure region and the adjustment region. Further, as the reticle 28 moves in either direction between the exposure region and the adjustment region, the infrared sensors 472 of the upper sensor array 448U are able to provide accurate and precise temperature measurements along the top surface 28T of the reticle 28 in the direction of motion of the reticle 28 between the exposure region and the adjustment region.

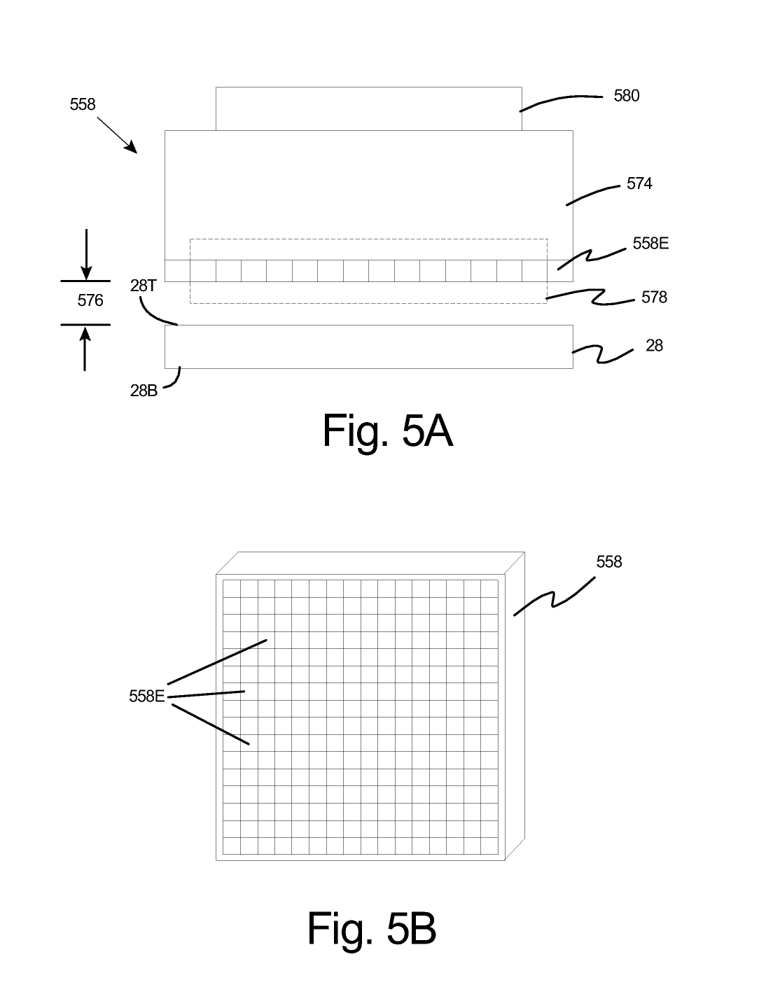

FIG. 5A is a simplified schematic illustration of the reticle 28 and an embodiment of a temperature adjuster 558 that can be used in conjunction with the reticle distortion control system 226 illustrated in FIG. 2. In particular, the temperature adjuster 558 can be used in conjunction with the reticle distortion control system 226 to control the temperature of the reticle 28 and thus to control, inhibit and/or reduce any undesired distortion of the reticle 28.

It should be noted that while the temperature of the bottom surface 28B of the reticle 28 is more critical, as that is where the pattern to be transferred to the wafer 30 (illustrated in FIG. 1) is located, the bottom surface 28B of the reticle 28 may not be readily coolable due to the presence of a pellicle (not illustrated) attached to and/or covering and protecting the bottom surface 28B of the reticle 28. Accordingly, as illustrated herein, heat may be removed from the reticle 28, by convection or conduction, by providing a temperature adjuster 558 that is configured to adjust the temperature of, e.g., to cool or heat, the top surface 28T of the reticle 28. By cooling or heating the top surface 28T of the reticle 28, the distortion of the reticle 28 may be controlled.

Additionally, it should be appreciated that in addition to compensating for thermal distortion in the reticle 28, the temperature adjuster 558 may also be used to intentionally distort the reticle 28. By way of example, in different embodiments, the temperature adjuster 558 may be used to distort the reticle 28 in such a way as to compensate for lens distortion, and/or to improve an overlay between multiple images using at least two different reticles, e.g., in a double patterning exposure process.

The design of the temperature adjuster 558 may vary depending on the specific requirements of the exposure apparatus 10. For example, the design of the temperature adjuster 558 may include any of the designs as described in detail in U.S. patent application Ser. No. 12/643,932 filed on Dec. 21, 2009 and entitled “Reticle Error Reduction By Cooling”. As far as is permitted, the contents of U.S. patent application Ser. No. 12/643,932 are incorporated herein by reference. Additionally, feedback control, such as is provided herein, is required to utilize the temperature adjuster 558 illustrated in FIG. 5A.

By way of example, the temperature adjuster 558, as illustrated in FIG. 5A, can include a heat exchanger 574. In certain embodiments, the temperature adjuster 558 may include any suitable heat exchanger 574, as for example, a liquid-cooled copper heat exchanger. The temperature adjuster 558 is typically relatively cold, although it should be appreciated that the temperature of the temperature adjuster 558 may generally vary. In some embodiments, the temperature adjuster 558 may be cooled to between approximately zero degrees Celsius and approximately forty degrees Celsius. More preferably, the temperature adjuster 558 may be cooled to between approximately fifteen degrees Celsius and approximately twenty-five degrees Celsius.

The temperature adjuster 558 may be arranged such that when the temperature adjuster 558 is brought within a particular distance from the top surface 28T of the reticle 28, heat is transferred between the top surface 28T of the reticle 28 and the temperature adjuster 558, e.g. the adjuster elements 558E. Accordingly, to remove heat from the reticle 28, the reticle 28 may be positioned at a gap distance 576 from the temperature adjuster 558, such that the temperature adjuster 558 may effectively obtain heat from the reticle 28 substantially without coming into contact with the reticle 28. The gap distance 576 may vary widely. For instance, the gap distance 576 may be in the range of between approximately 0.1 micrometers (μm) and approximately thirty μm. In one embodiment, the gap distance 576 may be approximately twenty μm.

Further, the temperature adjuster 558, as illustrated herein, can include a plurality of adjuster elements 558E, which may be configured to provide different amounts of cooling to selected regions of the reticle 28 while not providing cooling to other regions of the reticle 28. For example, the temperature adjuster 558, under control of the controller 260 (illustrated in FIG. 2), may provide cooling to only those regions of the reticle 28 from which heat is to be removed. Alternatively, the temperature adjuster 558 may be arranged to provide substantially the same amount of cooling to all regions of the reticle 28.

The temperature adjuster 558, i.e. the heat exchanger 574, may further include an optional adapter plate 578 which may be arranged to be approximately the same size as a mask pattern (not shown) on reticle 28. In one embodiment, the adapter plate 578 may be configured to substantially complement the mask pattern, e.g., such that a surface of adapter plate 578 is effectively non-flat. In general, however, the adapter plate 578 does not need to be non-flat, and does not need to complement the mask pattern. Additionally and/or alternatively, the adapter plate 578 may be removable such that heat exchanger 574 may remove heat from reticle 28 both with and without the adapter plate 578.

In general, the reticle 28 may be positioned at the gap distance 576 substantially underneath the heat exchanger 574 at any suitable time. For example, the reticle 28 may be positioned at the gap distance 576 from the heat exchanger 574 while the reticle 28 is substantially stationary, such as during a wafer exchange process when reticle 28 is effectively not in use. Alternatively, the reticle 28 may be positioned at the gap distance 576 from the heat exchanger 574 while reticle 28 is moving.

As illustrated herein, the temperature adjuster 558 can further include an actuator 580, e.g., a linear actuator, which is adapted to move the heat exchanger 574 as necessary. For example, the actuator 580 may be configured to position the heat exchanger 574 at the gap distance 576 from the reticle 28 as needed to remove heat from the reticle 28, and to remove the heat exchanger 574 from the vicinity of the reticle 28 when heat removal is not needed. Alternatively, the temperature adjuster 558 can be designed without the actuator 580.

FIG. 5B is a simplified bottom perspective view of a portion of the temperature adjuster 558 illustrated in FIG. 5A. In particular, FIG. 5B illustrates the plurality of adjuster elements 558E that can be utilized to provide varying amounts of temperature adjustment to the various regions of the reticle 28 (illustrated in FIG. 5A) in order to effectively control the temperature of the reticle 28 and to control, inhibit and/or reduce any undesirable distortion of the reticle 28.

In one embodiment, as illustrated in FIG. 5B, the temperature adjuster 558 can include two hundred fifty-six adjuster elements 558E that are similarly sized and are positioned in a sixteen by sixteen square array, wherein each of the adjuster elements 558E is approximately the same size. Alternatively, the temperature adjuster 558 can be designed to include more than two hundred fifty-six or less than two hundred fifty-six adjuster elements 558E, and/or the adjuster elements 558E can be positioned with a different spatial relationship relative to each other, and/or the adjuster elements 558E can be of different sizes.

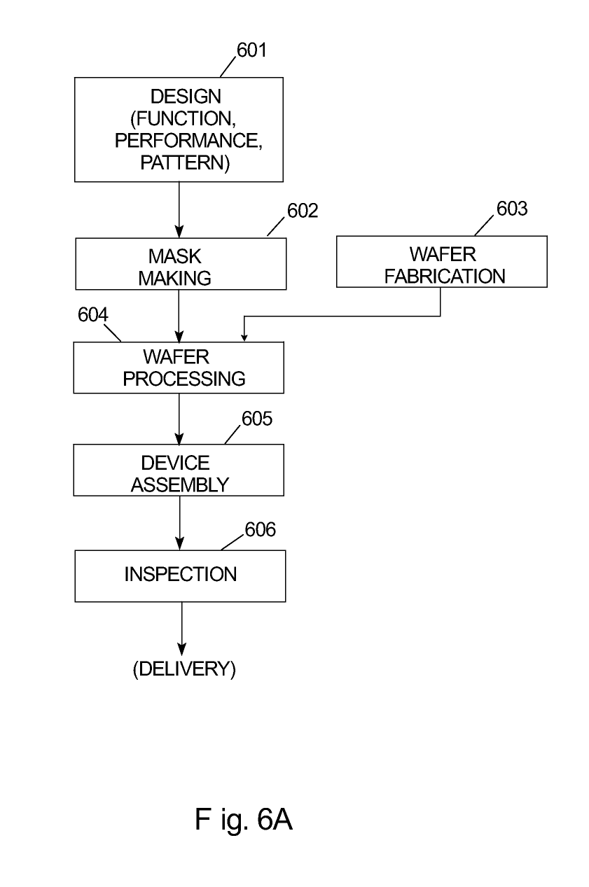

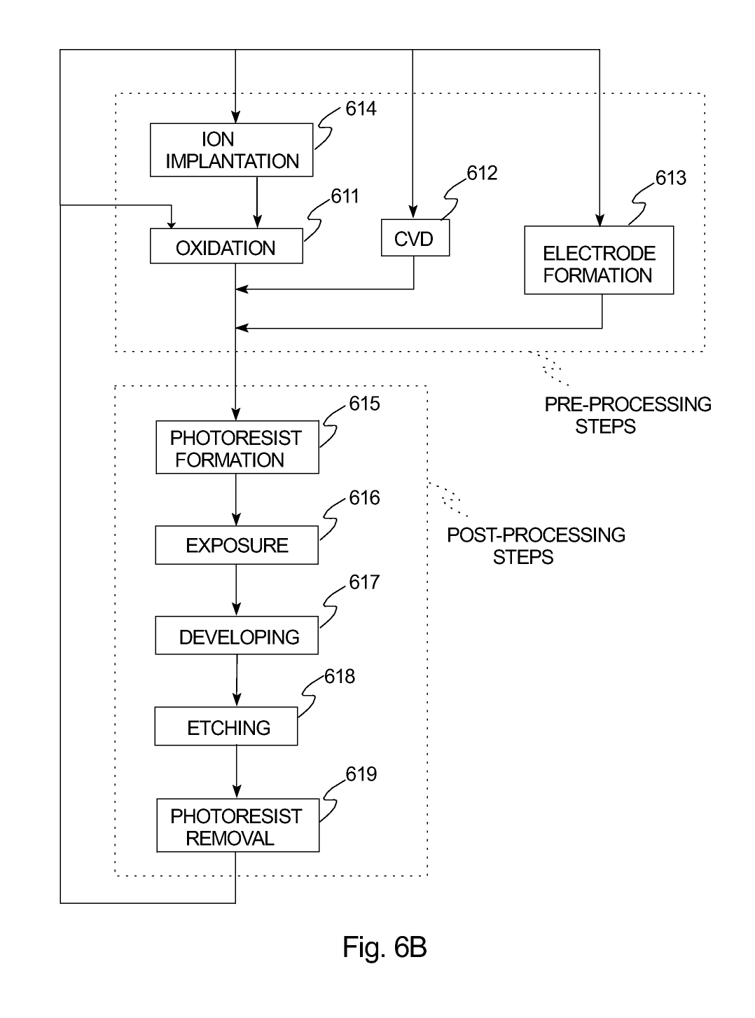

Semiconductor devices can be fabricated using the above described systems, by the process shown generally in FIG. 6A. In step 601 the device's function and performance characteristics are designed. Next, in step 602, a mask (reticle) having a pattern is designed according to the previous designing step, and in a parallel step 603 a substrate is made. The mask pattern designed in step 602 is exposed onto the substrate from step 603 in step 604 by a photolithography system described hereinabove in accordance with the present invention. In step 605 the semiconductor device is assembled (including the dicing process, bonding process and packaging process), finally, the device is then inspected in step 606.

FIG. 6B illustrates a detailed flowchart example of the above-mentioned step 604 in the case of fabricating semiconductor devices. In FIG. 6B, in step 611 (oxidation step), the substrate surface is oxidized. In step 612 (CVD step), an insulation film is formed on the substrate surface. In step 613 (electrode formation step), electrodes are formed on the substrate by vapor deposition. In step 614 (ion implantation step), ions are implanted in the substrate. The above mentioned steps 611-614 form the preprocessing steps for semiconductor wafers during processing, and selection is made at each step according to processing requirements.

At each stage of processing, when the above-mentioned preprocessing steps have been completed, the following post-processing steps are implemented. During post-processing, first, in step 615 (photoresist formation step), photoresist is applied to a substrate. Next, in step 616 (exposure step), the above-mentioned exposure device is used to transfer the circuit pattern of a mask (reticle) to a substrate. Then in step 617 (developing step), the exposed substrate is developed, and in step 618 (etching step), parts other than residual photoresist (exposed material surface) are removed by etching. In step 619 (photoresist removal step), unnecessary photoresist remaining after etching is removed.

Multiple circuit patterns are formed by repetition of these preprocessing and post-processing steps.

While a number of exemplary aspects and embodiments of a reticle distortion control system 26 have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. An apparatus for controlling the distortion of a reticle, the reticle including a plurality of regions, the apparatus comprising:
a temperature adjuster including a plurality of adjuster elements that individually adjust the temperature of the plurality of regions of the reticle; and
a control system including a state observer that estimates an estimated physical condition of the reticle; and a controller that controls the adjuster elements of the temperature adjuster based at least in part on the estimated physical condition.

2. The apparatus of claim 1 further comprising a sensor that senses a sensed physical condition of the reticle, wherein the state observer estimates the estimated physical condition of the reticle based at least in part on the sensed physical condition.

3. The apparatus of claim 2 wherein the control system further includes a first comparator that compares the sensed physical condition with the estimated physical condition and generates a first physical condition error based on the difference between the sensed physical condition and the estimated physical condition; and wherein the first physical condition error is provided to the state observer, and the state observer improves the estimate of the estimated physical condition based at least in part on the first physical condition error.

4. The apparatus of claim 2 wherein the sensor includes one or more of a temperature sensor and an alignment mark sensor.

5. The apparatus of claim 1 further comprising an evaluator that evaluates an evaluated physical condition of the reticle, wherein the state observer estimates the estimated physical condition of the reticle based at least in part on the evaluated physical condition.

6. The apparatus of claim 5 wherein the control system further includes a first comparator that compares the evaluated physical condition with the estimated physical condition and generates a first physical condition error based on the difference between the evaluated physical condition and the estimated physical condition; and wherein the first physical condition error is provided to the state observer, and the state observer improves the estimate of the estimated physical condition based at least in part on the first physical condition error.

7. The apparatus of claim 6 wherein the evaluator includes a pattern distortion evaluator.

8. The apparatus of claim 1 wherein the control system further includes a second comparator that compares the estimated physical condition with a desired physical condition of the reticle, the second comparator generating a second physical condition error based on the difference between the estimated physical condition and the desired physical condition.

9. The apparatus of claim 8 wherein the estimated physical condition and the desired physical condition relate to a pattern distortion of the reticle.

10. The apparatus of claim 8 wherein the physical condition error is provided to the controller, and the controller controls the adjuster elements of the temperature adjuster based at least in part on the second physical condition error.

11. The apparatus of claim 1 wherein the state observer estimates the estimated physical condition of the reticle based at least in part on one or more of (i) a pattern density of the reticle, (ii) a gas film thickness between the temperature adjuster and the reticle, (iii) a convection rate of the reticle, and (iv) a heat transfer rate through a control surface of each of the plurality of adjuster elements.

12. An exposure apparatus for transferring an image from the reticle to a device, the exposure apparatus comprising: a stage assembly that moves the reticle and the apparatus of claim 1 for controlling the distortion of the reticle.

13. A method for controlling the distortion of a reticle, the reticle including a plurality of regions, the method comprising the steps of:
estimating an estimated physical condition of the reticle with a state observer;
individually adjusting the temperature of the plurality of regions of the reticle with a temperature adjuster having a plurality of adjuster elements; and
controlling the adjuster elements of the temperature adjuster with a controller based at least in part on the estimated physical condition.

14. The method of claim 13 further comprising the step of sensing a sensed physical condition of the reticle with a sensor, and wherein the step of estimating includes the step of estimating the estimated physical condition of the reticle with the state observer based at least in part on the sensed physical condition.

15. The method of claim 14 further comprising the steps of generating a first physical condition error with a first comparator based on the difference between the sensed physical condition and the estimated physical condition; and improving the estimate of the estimated physical condition with the state observer based at least in part on the first physical condition error.

16. The method of claim 13 further comprising the step of evaluating an evaluated physical condition of the reticle with an evaluator, and wherein the step of estimating includes the step of estimating the estimated physical condition of the reticle with the state observer based at least in part on the evaluated physical condition.

17. The method of claim 16 further comprising the steps of generating a first physical condition error with a first comparator based on the difference between the evaluated physical condition and the estimated physical condition; and improving the estimate of the estimated physical condition with the state observer based at least in part on the first physical condition error.

18. The method of claim 13 further including the step of generating a second physical condition error with a second comparator based on the difference between the estimated physical condition and a desired physical condition.

19. The method of claim 18 wherein the step of generating the second physical condition error includes the estimated physical condition and the desired physical condition relating to a pattern distortion of the reticle.

20. The method of claim 18 wherein the step of controlling includes the step of controlling the adjuster elements of the temperature adjuster with a controller based at least in part on the second physical condition error.

21. A method for transferring an image from the reticle to a device, the method comprising the steps of: moving the reticle with a stage assembly, and controlling the distortion of the reticle by the method of claim 13.

22. An apparatus for controlling the distortion of a reticle, the reticle including a plurality of regions, the apparatus comprising:
a temperature adjuster including a plurality of adjuster elements that individually adjust the temperature of the plurality of regions of the reticle;
a sensor that senses a sensed physical condition of the reticle;
an evaluator that evaluates an evaluated physical condition of the reticle; and
a control system including (i) a state observer that estimates an estimated physical condition of the reticle based at least in part on the sensed physical condition and the evaluated physical condition; (ii) a comparator that compares the estimated physical condition with a desired physical condition of the reticle, the comparator generating a physical condition error based on the difference between the estimated physical condition and the desired physical condition; and (iii) a controller that controls the adjuster elements of the temperature adjuster based at least in part on the physical condition error.

23. The apparatus of claim 22 wherein the control system further includes a second comparator that compares the sensed physical condition with the estimated physical condition and generates a second physical condition error based on the difference between the sensed physical condition and the estimated physical condition; and a third comparator that compares the evaluated physical condition with the estimated physical condition and generates a third physical condition error based on the difference between the evaluated physical condition and the estimated physical condition; and wherein the second physical condition error and the third physical condition error are provided to the state observer, and the state observer improves the estimate of the estimated physical condition based at least in part on the second physical condition error and the third physical condition error.

24. The exposure apparatus that exposes a pattern formed on a mask onto a substrate, comprising:
a temperature adjuster including a plurality of adjuster elements that adjust the temperature of the plurality of regions of the mask; and
a control system, including a state observer that estimates an estimated physical condition of the mask, and that controls the adjuster elements of the temperature adjuster utilizing at least in part on the estimated physical condition.
